(19) United States
(12) Patent Application Publication
(10) Pub. No.: US 2024/0284008 A1
(43) Pub. Date: Aug. 22, 2024

(54) SERVER, TERMINAL, AND METHOD

(71) Applicant: 17LIVE Japan Inc, Tokyo (JP)

(72) Inventors: Ka Ho FONG, Tokyo (JP); Chou-Keng WU, Tokyo (JP); Yun-An LIN, Tokyo (JP)

(21) Appl. No.: 18/240,133

(22) Filed: Aug. 30, 2023

(30) Foreign Application Priority Data
Feb. 16, 2023 (JP) 2023-022229

(51) Int. Cl. H04N 21/4784; H04N 21/2187; H04N 21/4788

(52) U.S. Cl. CPC H04N 21/4784; H04N 21/2187; H04N 21/4788

(57) ABSTRACT

A server includes a storage adapted to hold video data of past livestreams; and a generating unit adapted to generate, in response to reception of a viewing request for a past livestream, provision data for the viewing request, the provision data being generated such that, among interactions made in the livestream, output of an interaction that meets a predetermined criterion is restricted.

### CROSS-REFERENCE TO RELATED APPLICATIONS

This application is based on and claims the benefit of priority from Japanese Patent Application Serial No. 2023-22229 (filed Feb. 16, 2023), the contents of which are hereby incorporated by reference in its entirety.

### TECHNICAL FIELD

The present disclosure relates to a server, a terminal, and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced. And nowadays or in the Reiwa period (2019 to present), with the sophistication of smartphones and further improvements in network speed as typified by 5G, services that enable real-time communication through video, especially live-streaming services, are gaining recognition. The number of users of live-streaming services is expanding, especially among young people, as such services allow people to share the same good time even when they are in the separate locations from each other.

An archive function is known to allow users who could not watch livestreams in real time can enjoy the livestreams later by recording and saving them (see, for example, Japanese Patent Application Publication No. 2022-130081 (“the '081 Publication”)).

The archive function is convenient because it allows users to view past livestreams whenever they wish. However, since there is a time gap between when the archive is viewed and when the livestream was broadcast, the environment and conditions may change. Conventional archive functions such as described in the '081 Publication cannot deal with such change in environment and conditions.

### SUMMARY

In view of the above, one object of the present disclosure is to provide a technology that provides flexibility in the archive function of live-streaming.

One aspect of the disclosure relates to a server. The server includes: a storage adapted to hold video data of past livestreams; and a generating unit adapted to generate, in response to reception of a viewing request for a past livestream, provision data for the viewing request, the provision data being generated such that, among interactions made in the livestream, output of an interaction that meets a predetermined criterion is restricted.

Another aspect of the disclosure relates to a terminal. The terminal includes: one or more processors; and memory storing one or more computer programs configured to be executed by the one or more processors. The one or more computer programs including instructions for: transmitting a viewing request for a past livestream to a server over a network; and determining, when playing back video data of the past livestream corresponding to the viewing request, whether to output an effect corresponding to a gift used in the livestream by a participant at a time when the livestream was broadcast.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### Advantageous Effects

According to the aspects of the invention, it is possible to increase flexibility in the archive function of livestreams.

### BRIEF DESCRIPTION OF THE DRAWINGS

FIG. 1 schematically illustrates a configuration of a live-streaming system in one embodiment.

FIG. 2 is a block diagram showing functions and configuration of a user terminal of FIG. 1.

FIG. 3 is a block diagram showing functions and configuration of a server shown in FIG. 1.

FIG. 4 is a data structure diagram showing, as an example, a stream DB shown in FIG. 3.

FIG. 5 is a data structure diagram showing, as an example, a user DB shown in FIG. 3.

FIG. 6 is a data structure diagram showing, as an example, a gift DB shown in FIG. 3.

FIG. 7 is a data structure diagram of an example of an archive DB in FIG. 3.

FIG. 8 is a data structure diagram showing an example of a gift history DB shown in FIG. 3.

FIG. 9 is a data structure diagram showing an example of a comment history DB in FIG. 3.

FIG. 10 is a data structure diagram showing an example of interaction data.

FIG. 11 is a flowchart showing a series of steps performed in the live-streaming system when starting to view an archive.

FIG. 12 is a representative screen image of a profile screen displayed on the display of the active user's user terminal.

FIG. 13 is a representative screen image of an archive display screen in non-display mode shown on the display of the active user's user terminal.

FIG. 14 is a representative screen image of an archive display screen in a display mode displayed on the display of the active user's user terminal.

FIG. 15 is a representative screen image of an archive display screen in the display mode displayed on the display of the active user's user terminal.

FIG. 16 is a block diagram showing an example of a hardware configuration of the information processing device according to the embodiment.

FIG. 17 is a data structure diagram showing an example of a restricted gift list held by a user terminal from which an archive viewing request is sent.

### DESCRIPTION OF THE EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

A live-streaming system according to an embodiment hosts a livestream in real time, and also records and saves the livestream. When a user of a live-streaming platform requests the system to view a past livestream (hereinafter referred to as “archive”), the system provides video data of the archive and interaction data to a user terminal of the user. The interaction data is data of interactions (gifts, comments, etc.) that took place in the livestream that was the source of the archive. The system generates the interaction data in such a way that output of interactions that meet a specified restriction criterion among interactions that took place in the live-stream are restricted.

This makes it possible to differentiate the output of interactions during a livestream from the output of interactions during playback of the archived livestream. For example, when there are some contractual restrictions or time limits related to copyrights on the use of gift effects, such restrictions or time limits can be set as the restriction criteria. Gift effects that do not meet the restriction criteria will not be outputted during the playback of the archived livestream. For example, when the restriction criterion is that the data size and/or processing amount of an effect is greater than a threshold value, it is possible to skip the effect that is slow to be displayed during the archive playback, resulting in a more comfortable viewing experience. According to the embodiment, the reproducibility of archived livestreams can be improved by outputting interactions together during playback of the archived livestreams. In addition, by determining whether interactions should be outputted, it is possible to finely cope with differences between conditions at the time of the live-stream and conditions at the time of the playback of the archived livestream.

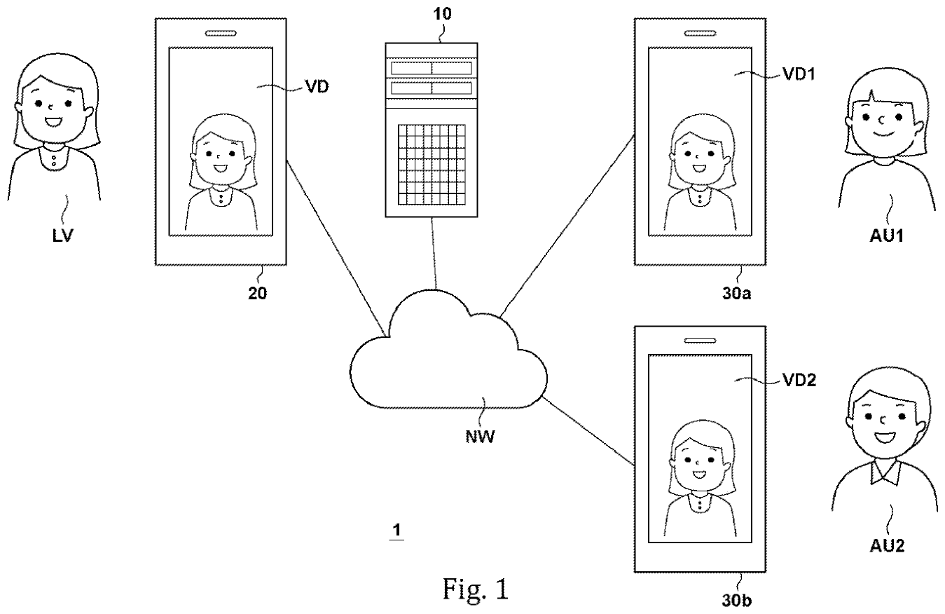

FIG. 1 schematically illustrates the configuration of a live-streaming system 1 according one embodiment of the disclosure. The live-streaming system 1 provides an interactive live-streaming service that allows a live-streamer LV (also referred to as a liver or streamer) and a viewer AU (also referred to as audience) (AU1, AU2 . . . ) to communicate in real time. As shown in FIG. 1, the live-streaming system 1 includes a server 10, a user terminal 20 on the live-streamer side, and user terminals 30 (30a, 30b . . . ) on the audience side. In addition to the live-streamer who is live-streaming and the viewers who watch the live-stream, there may be users who have logged in the live-streaming platform but is neither live-streaming nor watching the livestream. Such users are referred to as active users. The live-streamer, the viewers, and the active users may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminals 30 are interconnected so as to be able to communicate with each other over the various wired or wireless network NW.

The live-streaming system 1 involves the live-streamer LV, the viewers AU, and an administrator (not shown) who manages the server 10. The live-streamer LV is a person who broadcasts contents in real time by recording the contents with his/her user terminal 20 and uploading them directly to the server 1. Examples of the contents may include the live-streamer's own songs, talks, performances, fortune-telling, gameplays, and any other contents. The administrator provides a platform for live-streaming contents on the server 10, and also mediates or manages real-time interactions between the live-streamer LV and the viewers AU. The viewers AU access the platform at their user terminals 30 to select and view a desired content. During live-streaming of the selected content, the viewer AU performs operations to comment, cheer, or ask fortune-telling via the user terminal 30, the streamer LV who is delivering the content responds to such a comment, cheer, or request and such response is transmitted to the viewer AU via video and/or audio, thereby establishing an interactive communication.

As used herein, the term “live-streaming” or “livestream” may mean a mode of data transmission that allows a content recorded at the user terminal 20 of the live-streamer LV to be played and viewed at the user terminals 30 of the viewers AU substantially in real time, or it may mean a live broadcast realized by such a mode of transmission. The live-streaming may be achieved using existing live-streaming technologies such as HTTP Live Streaming, Common Media Application Format, Web Real-Time Communications, Real-Time Messaging Protocol and MPEG DASH. The live-streaming includes a transmission mode in which, while the live-streamer LV is recording contents, the viewers AU can view the contents with a certain delay. The delay is acceptable as long as interaction between the live-streamer LV and the viewers AU can be at least established. Note that the live-streaming is distinguished from so-called on-demand distribution, in which contents are entirely recorded and the entire data is once stored on the server and the server provides users with the data at any subsequent time upon request from the users. The provision of past livestreams, i.e., archives, is considered the on-demand distribution.

The term “video data” herein refers to data that includes image data (also referred to as moving image data) generated using an image capturing function of the user terminals 20 and 30 and audio data generated using an audio input function of the user terminals 20 and 30. Video data is reproduced in the user terminals 20 and 30, so that the users can view contents. In this embodiment, it is assumed that between video data generation at the live-streamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the live-streamer's user terminal and then played back at the viewer's user terminal via the server 10, the video data generated at the live-streamer's user terminal, the video data that passes through the server 10, and the video data received and reproduced at the viewer's user terminal are all the same video data.

In the example in FIG. 1, a live-streamer LV is live-streaming his/her talk. The user terminal 20 of the live-streamer LV generates video data by recording images and sounds of the live-streamer LV who is talking, and the generated data is transmitted to the server 10 over the network NW. At the same time, the user terminal 20 displays the recorded video image VD of the live-streamer LV on the display of the user terminal 20 to allow the live-streamer LV to check what is to be streamed.

The user terminals 30a and 30b of the viewers AU1 and AU2 respectively, who have requested the platform to enable them to view the livestream of the live-streamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the live-streamer LV, and the audio outputted at the user terminals 30a and 30b is substantially the same as the audio recorded by the user terminal 20 of the live-streamer LV.

Recording of the images and sounds at the user terminal 20 of the live-streamer LV and reproduction of the video data at the user terminals 30a and 30b of the viewers AU1 and AU2 are performed substantially simultaneously. The viewer AU1 may type a comment about the talk of the live-streamer LV on the user terminal 30a, and the server 10 may display the comment on the user terminal 20 of the live-streamer LV in real time and also display the comment on the user terminals 30a and 30b of the viewers AU1 and AU2, respectively. The live-streamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the live-streamer LV and the viewer AU1. In this way, the live-streaming system 1 realizes the live-streaming that enables the interactive communication, not one-way communication.

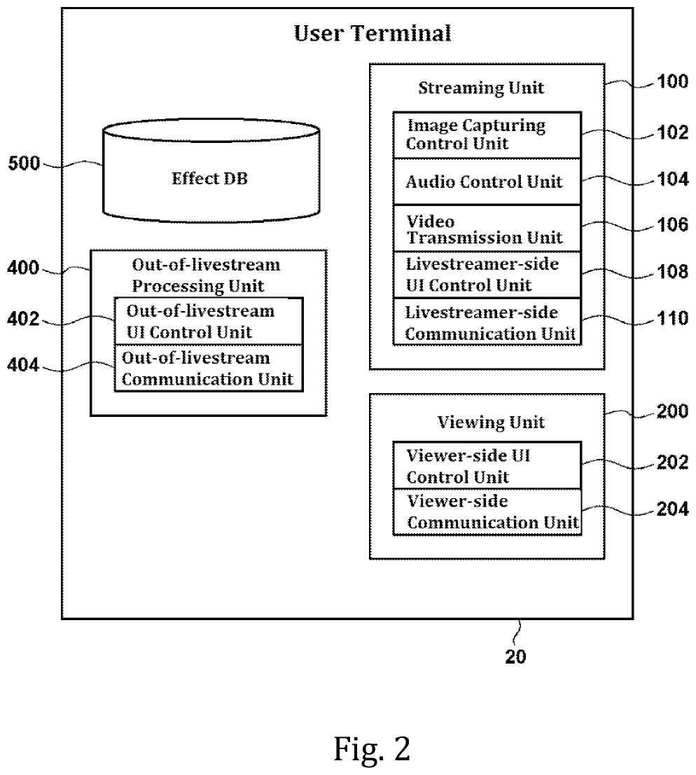

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The live-streamer LV and the viewers AU download and install a live-streaming application program (hereinafter referred to as a live-streaming application), onto the user terminals 20 and 30 from a download site over the network NW. Alternatively, the live-streaming application may be pre-installed on the user terminals 20 and 30. When the live-streaming application is executed on the user terminals 20 and 30, the user terminals 20 and 30 communicate with the server 10 over the network NW to implement various functions. Hereinafter, the functions implemented by (processors such as CPUs of) the user terminals 20 and 30 by running the live-streaming application will be described as functions of the user terminals 20 and 30. These functions are realized in practice by the live-streaming application on the user terminals 20 and 30. In any other embodiments, these functions may be realized by a computer program written in a programming language such as HTML (HyperText Markup Language), which is transmitted from the server 10 to web browsers of the user terminals 20 and 30 over the network NW and executed by the web browsers.

The user terminal 20 includes a streaming unit 100 for generating a video data in which the user's image and sound are recorded and providing the video data to the server 10, a viewing unit 200 for acquiring and reproducing the video data from the server 10, and an out-of-live-stream processing unit 400 for processing requests made by active users, and an effect DB 500 for holding data of gift effects. Effects may include still images, videos, animation, sound, and the like. The user activates the streaming unit 100 to live-stream, the viewing unit 200 to view a livestream, and the out-of-live-stream processing unit 400 to look for a live-stream, view a live-streamer's profile, or watch an archive. The user terminal having the streaming unit 100 activated is the live-streamer's terminal, i.e., the user terminal that generates video data, the user terminal having the viewing unit 200 activated is the viewer's terminal, i.e., the user terminal that reproduces video data, and the user terminal having the out-of-live-stream processing unit 400 activated is the active user's terminal.

The streaming unit 100 includes an image capturing control unit 102, an audio control unit 104, a video transmission unit 106, a streamer-side UI control unit 108, and a streamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The streamer-side UI control unit 108 controls a UI for the live-streamer. The streamer-side UI control unit 108 is connected to a display (not shown in FIG. 2), and displays a video on the display by reproducing the video data that is to be transmitted by the video transmission unit 106. The streamer-side UI control unit 108 is also connected to input means (not shown in FIG. 2) such as touch panels, keyboards, and displays, and obtains the live-streamer's input via the input means. The streamer-side UI control unit 108 superimposes a predetermined frame image on the video image. The frame image includes various user interface objects (hereinafter simply referred to as “objects”) for receiving inputs from the live-streamer, comments entered by the viewers, and information obtained from the server 10. The streamer-side UI control unit 108 receives, for example, the live-streamer's inputs made by the live-streamer tapping the objects.

The streamer-side communication unit 110 controls communication with the server 10 during a livestream. The streamer-side communication unit 110 transmits the content of the live-streamer's input that has been obtained by the streamer-side UI control unit 108 to the server 10 over the network NW. The streamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the live-stream in which the live-streamer and the viewer participate.

The viewer-side UI control unit 202 controls the UI for the viewer. The viewer-side UI control unit 202 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains viewer's input via the input means. The viewer-side UI control unit 202 superimposes a predetermined frame image on an image generated from the video data obtained from the server 10. The frame image includes various objects for receiving inputs from the viewer, comments entered by the viewer, and information obtained from the server 10. The viewer-side communication unit 204 transmits the content of the viewer's input that has been obtained by the viewer-side UI control unit 202 to the server 10 over the network NW.

The out-of-live-stream processing unit 400 includes an out-of-live-stream UI control unit 402 and an out-of-live-stream communication unit 404. The out-of-live-stream UI control unit 402 controls a UI for the active user. For example, the out-of-live-stream UI control unit 402 generates a livestream selection screen and shows the screen on the display. The livestream selection screen presents a list of live-streams to which the active user is currently invited to participate to allow the active user to select a live stream. The out-of-live-stream UI control unit 402 generates a profile screen for any user and shows the screen on the display. The out-of-live-stream UI control unit 402 displays a list of currently available archives on the profile screen and accepts selection of an archive by the active user.

The out-of-livestream communication unit 404 controls communication with the server 10 that takes place outside a livestream. The out-of-live-stream communication unit 404 receives, from the server 10 over the network NW, information necessary to generate the livestream selection screen, information necessary to generate the profile screen, and archived data. The out-of-live-stream communication unit 404 transmits the content of the active user's input to the server 10 over the network NW.

The out-of-livestream communication unit 404 generates a viewing request for the selected archive and sends it to the server 10 over the network NW. The out-of-livestream communication unit 404 receives the video data and interaction data of the archive requested by the viewing request. The out-of-live-stream UI control unit 402 reproduces the received video data to display archive video images on the display and output audio to the speaker. At the same time, the out-of-live-stream UI control unit 402 causes interactions specified by the interaction data, i.e., a gift effect(s) and comment(s), to be displayed on the display. This will be further descried later.

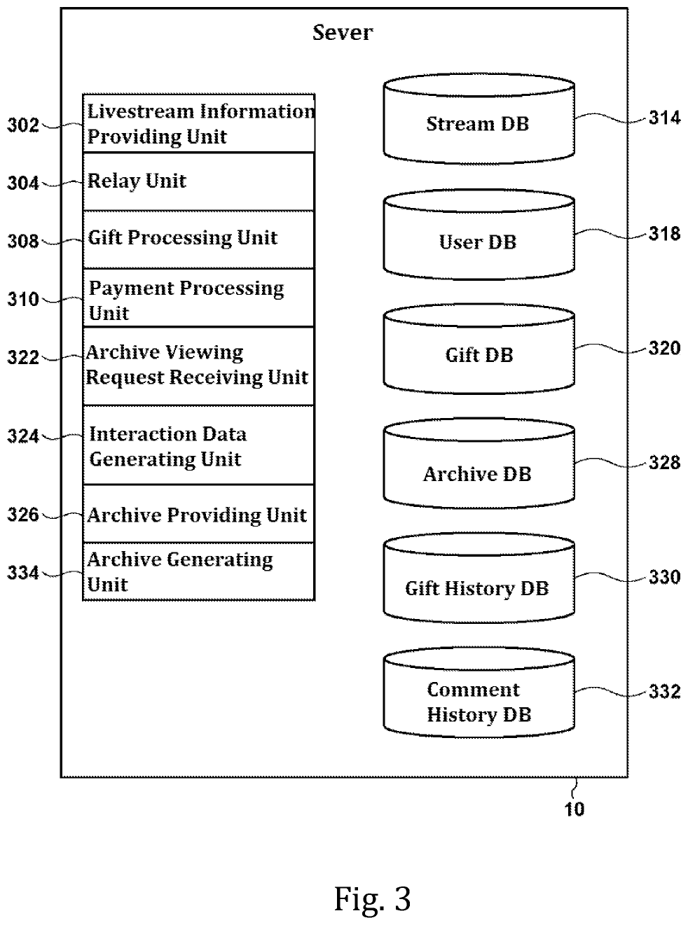

FIG. 3 is a block diagram showing functions and configuration of the server 10 of FIG. 1. The server 10 includes a livestream information providing unit 302, a relay unit 304, a gift processing unit 308, a payment processing unit 310, an archive viewing request receiving unit 332, an interaction data generating unit 324, an archive providing unit 326, an archive generating unit 334, a stream DB 314, a user DB 318, a gift DB 320, an archive DB 328, a gift history DB 330, and a comment history DB 332.

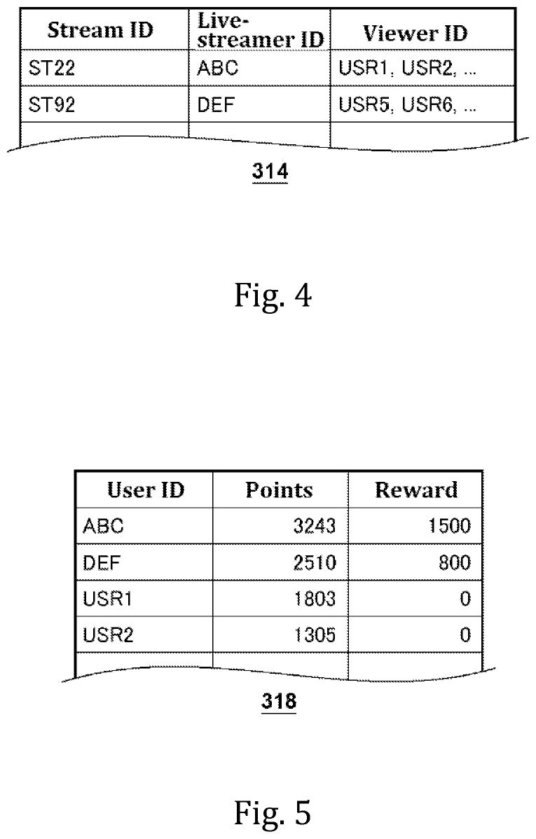

FIG. 4 is a data structure diagram showing an example of the stream DB 314 of FIG. 3. The stream DB 314 holds information regarding livestreams currently taking place. The stream DB 314 stores a stream ID identifying a livestream on a live-streaming platform provided by the live-streaming system 1, a live-streamer ID, which is a user ID identifying the live-streamer who provides the livestream, and a viewer ID, which is a user ID identifying a viewer of the livestream, in association with each other.

In the live-streaming platform provided by the live-streaming system 1 of the embodiment, when a user livestreams, the user is referred to as a live-streamer, and when the same user views a livestream streamed by another user, the user is referred to as a viewer. Therefore, the distinction between a live-streamer and a viewer is not fixed, and a user ID registered as a live-streamer ID at one time may be registered as a viewer ID at another time.

FIG. 5 is a data structure diagram showing an example of the user DB 318 of FIG. 3. The user DB 318 holds information regarding users. The user DB 318 stores a user ID identifying a user, points owned by the user, and the reward awarded to the user, in association with each other.

The points are an electronic representation of value circulated in the live-streaming platform. The user can purchase the points using a credit card or other means of payment. The reward is an electronic representation of value defined in the live-streaming platform and is used to determine the amount of money the live-streamer receives from the administrator of the live-streaming platform. In the live-streaming platform, when a viewer gives a gift to a live-streamer within or outside a livestream, the viewer's points are consumed and, at the same time, the live-streamer's reward is increased by a corresponding amount.

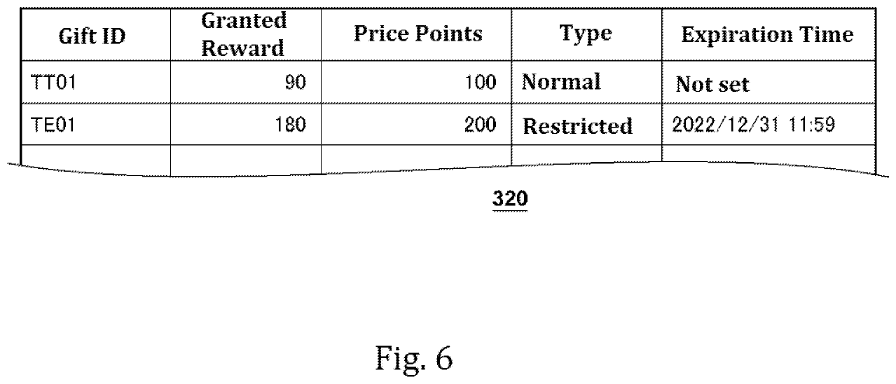

FIG. 6 is a data structure diagram showing an example of the gift DB 320 of FIG. 3. The gift DB 320 holds information regarding gifts available for the viewers in relation to the live-streaming. A gift is electronic data with the following characteristics:
It can be purchased in exchange for the points or money, or can be given for free.
It can be given by a viewer to a live-streamer. Giving a gift to a live-streamer is also referred to as using the gift or throwing the gift.
Some gifts may be purchased and used at the same time, and some gifts may be used by the viewer at any time after purchased.
When a viewer gives a gift to a live-streamer, the live-streamer is given a corresponding reward.
When a gift is used, the use may trigger an effect associated with the gift. For example, an effect corresponding to the gift will appear on the live-streaming room screen.

The gift DB 320 stores: a gift ID for identifying a gift; a reward to be awarded to a streamer when the gift is given to the streamer; price points that is the price to be paid for the use of the gift; a type of the gift; and an expiration time for the gift, in association with each other. A viewer is able to give a desired gift to a live-streamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator is able to desirably set the relationship between the reward to be awarded and the price points. For example, it may be set as the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

There are two types of gifts: “normal” and “restricted”. The normal gifts are gifts with no restrictions on use of the gifts. The restricted gifts are gifts that each have an expiration time set by contract or other agreement. Use of a restricted gift that has passed its expiration time is restricted during both livestream and archive playback. In the embodiment, such restriction is realized by checking the expiration time of the gift by referring to the gift DB 320 both during a livestream and during playback of the archived livestream. In the example of FIG. 6, a gift “TE01” can be used in a livestream performed on Dec. 30, 2022, but an effect of the gift “TE01” is not displayed when an archive of the livestream is played back on Jan. 10, 2023. The type and expiration time of the gift may be set by the administrator of the live-streaming platform.

Ways of restricting a predetermined gift include prohibiting the use of the predetermined gift, prohibiting the display of the effect of the predetermined gift, excluding the predetermined gift from the list of available gifts, limiting users who can use the predetermined gift, replacing the effect of the predetermined gift with another effect, applying a mask to the effect of the predetermined gift, and the like. In this embodiment, the display of the effect of the restricted gift is prohibited during playback of archives. In other words, the effect of the restricted gift will not be displayed. In addition, the name of the gift is removed from comments that mention the restricted gift.

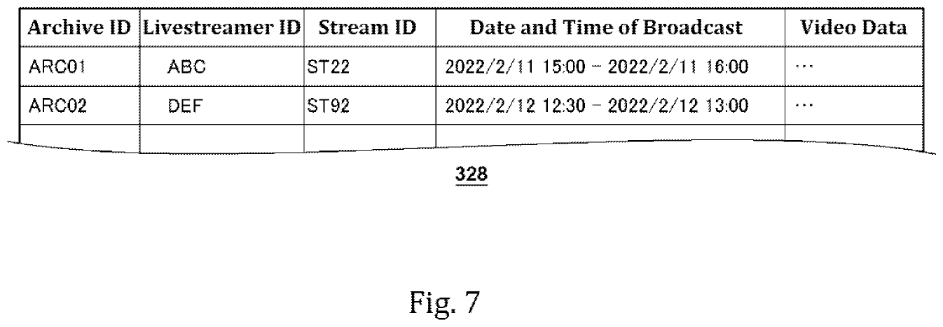

FIG. 7 is a data structure diagram of an example of the archive DB 328 in FIG. 3. The archive DB 328 holds metadata of an archive and the video data of the archive in association with the video data of the archive. The archive DB 328 holds an archive ID for identifying an archive of a livestream, the live-streamer ID of the live-streamer who hosted the livestream archived, the stream ID of the livestream archived, the date and time when the livestream was broadcast, and the video data of the archive of the livestream, in association with each other.

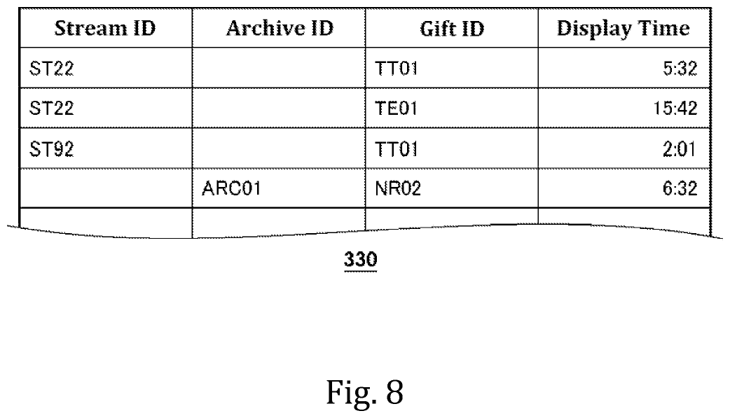

FIG. 8 is a data structure diagram showing an example of the gift history DB 330 of FIG. 3. The gift history DB 330 holds information on gifts used within or outside of livestreams. The gift history DB 330 records when and which gifts were used in which livestream or archived livestream. In particular, the gift history DB 330 holds information on gifts used within past livestreams. The gift history DB 330 holds the stream ID of a livestream in which a gift was used or the archive ID of an archive in which the gift was used, the gift ID of the gift, and display time, which is the time when an effect of the gift was displayed on the live-streamer's user terminal. The display time starts from 0 at the start of the corresponding livestream or archive.

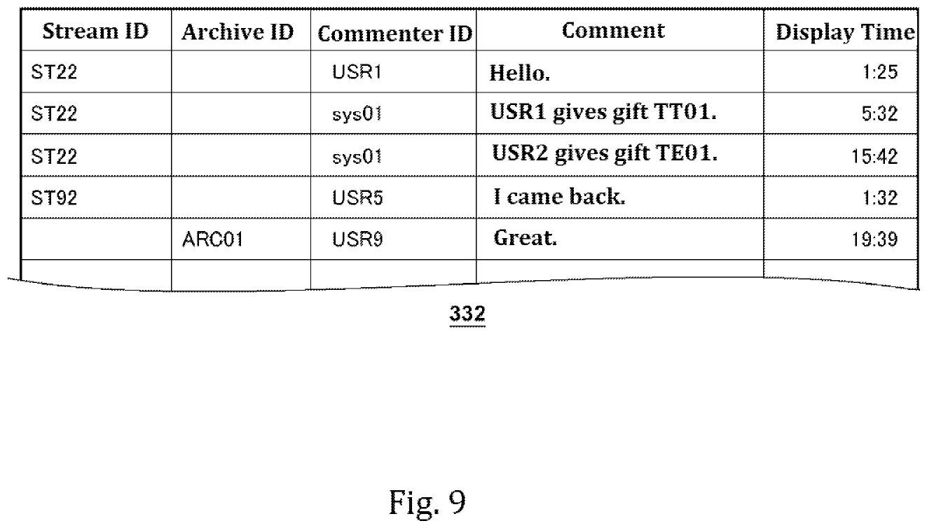

FIG. 9 is a data structure diagram showing an example of the comment history DB 332 of FIG. 3. The comment history DB 332 holds information on comments entered by participants (live-streamers and viewers) within and outside livestreams. The comment history DB 332 holds the stream ID of a livestream in which a comment was entered or the archive ID of an archive in which the comment was entered, a commenter ID which is the user ID of the user who entered the comment, and display time, which is the time when the comment was displayed on the live-streamer's user terminal.

Referring again to FIG. 3, upon reception of a notification over the network NW from the user terminal 20 of the live-streamer that the live-streamer starts a livestream, the stream information providing unit 302 registers in the stream DB 314 a stream ID identifying this livestream and the live-streamer ID of the live-streamer who performs the livestream. When the stream information providing unit 302 receives a request for information about livestreams from the out-of-live-stream communication unit 404 of a user terminal of an active user over the network NW, the stream information providing unit 302 refers to the stream DB 314 and makes a list of currently available livestreams. The stream information providing unit 302 transmits the generated list to the requesting user terminal over the network NW. The out-of-live-stream UI control unit 402 of the requesting user terminal generates a livestream selection screen based on the received list and shows the livestream selection screen on the display of the user terminal.

Once the out-of-live-stream UI control unit 402 of the user terminal receives the active user's selection of a livestream on the livestream selection screen, the out-of-livestream UI control unit 402 generates a stream request including the stream ID of the selected livestream, and transmits the stream request to the server 10 over the network NW. The stream information providing unit 302 starts to provide, to the requesting user terminal, the livestream identified by the stream ID included in the received stream request. The stream information providing unit 302 updates the stream DB 314 such that the user ID of the active user of the requesting user terminal is included in the viewer IDs corresponding to the stream ID. In this way, the active user can become a viewer of the selected livestream.

The relay unit 304 relays the video data from the streamer-side user terminal 20 to the viewer-side user terminal 30 in the livestream started by the stream information providing unit 302. The relay unit 304 receives from the viewer-side communication unit 204 a signal that represents user input by a viewer during the livestream or reproduction of the video data. The signal that represents user input may be an object specifying signal for specifying an object displayed on the display of the user terminal 30, and the object specifying signal includes the viewer ID of the viewer, the live-streamer ID of the live-streamer of the livestream that the viewer watches, and an object ID that identifies the object. When the object is a gift icon, the object ID is the gift ID. The object specifying signal in that case is a gift use signal indicating that the viewer uses a gift for the live-streamer. Similarly, the relay unit 304 receives from the streamer-side communication unit 110 of the streaming unit 100 in the user terminal 20 a signal that represents user input by the live-streamer during reproduction of the video data, such as the object specifying signal. The generation and transmission of the gift use signal at the user terminal may be realized using techniques described, for example, in Japanese Patent No. 7071718.

The gift processing unit 308 updates the user DB 318 so as to increase the reward for the live-streamer depending on the reward to be awarded of the gift identified by the gift ID included in the gift use signal. Specifically, the gift processing unit 308 refers to the gift DB 320 to specify a reward to be awarded for the gift ID included in the received gift use signal. The gift processing unit 308 then updates the user DB 318 to add the specified reward to be awarded to the reward for the live-streamer ID included in the gift use signal.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

The archive generating unit 334 generates an archive by obtaining video data of a livestream and registering it in the archive DB 328. Once the archive generating unit 334 receives from a live-streamer's user terminal 20 a notification that the live-streamer is going to start a livestream, the archive generating unit 334 starts recording the video data of the livestream provided by the user terminal 20. Upon end of the livestream, the archive generating unit 344 registers the metadata (archive ID, live-streamer ID, stream ID, live-streaming date and time) of the livestream and the video data recorded until then in the archive DB 328 in association with each other.

When a gift is used within a livestream or outside of a livestream (e.g., when viewing an archived livestream), the archive generating unit 334 registers information on the used gift in the gift history DB 330. When the gift use signal is received, the archive generating unit 334 registers the stream ID of the livestream or archive ID of the archived livestream in which the gift was used, the gift ID included in the gift use signal, and the time when the gift use signal was received, in the gift history DB 330 in association with each other. The server 10 interprets the time when the gift use signal is received as the display time when the corresponding gift is displayed.

The archive generating unit 334 registers information on comments entered within or outside livestreams (e.g., when viewing archived livestreams) in the comment history DB 332. When a comment is entered at a user terminal of a participant in a livestream, the user terminal generates a comment input signal including the stream ID of the livestream, the user ID of the participant, and the entered comment, and transmits the signal to the server 10 over the network NW. When the comment input signal is received, the archive generating unit 334 registers the stream ID included in the signal, the user ID included in the signal, the comment included in the signal, and the time when the signal was received, in the comment history DB 332, in association with each other. The user ID included in the comment input signal is registered as the commenter ID. The server 10 interprets the time when the comment input signal is received as the display time when the corresponding comment is displayed. Comments entered when viewing archived livestreams are similarly registered in the comment history DB 332.

The archive viewing request receiving unit 322 receives archive viewing requests, which are requests to view archives, from user terminals of the active users over the network NW. The archive viewing request includes the archive ID of the archive that an active user wishes to view.

When the archive viewing request is received by the archive viewing request receiving unit 322, the interaction data generating unit 324 and the archive providing unit 326 together generate provision data for the archive viewing request such that, among the interactions that took place in the livestream that is later archived with the archive ID included in the archive viewing request, the output of interactions that meet the restriction criterion is restricted. The interactions include gifts used by participants in the livestream and comments displayed in the livestream. For the gifts, the interaction data generating unit 324 and the archive providing unit 326 together generate the provision data such that the output of a restricted gift is restricted if the expiration time of the restricted gift has passed when the archive viewing request is received.

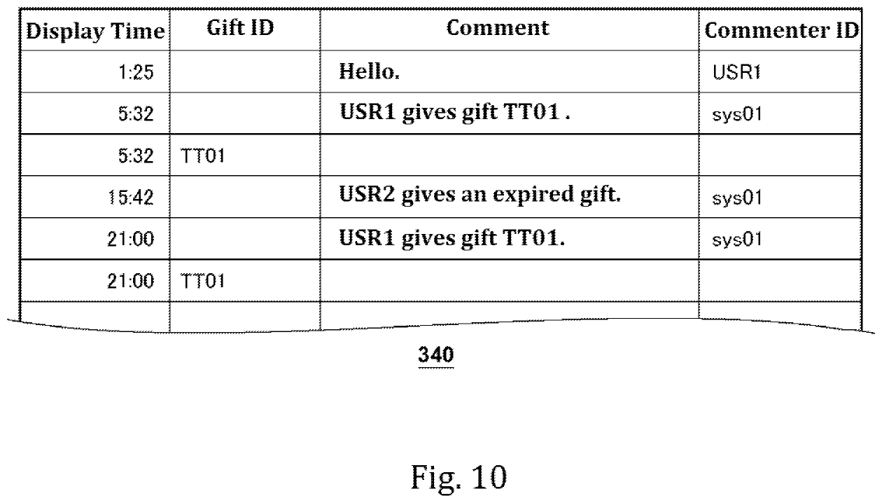

The interaction data generating unit 324 generates interaction data corresponding to the archive identified by the archive ID included in the received archive viewing request. FIG. 10 is a data structure diagram showing an example of interaction data 340. The interaction data 340 includes information on gifts used in the livestream that is archived as the identified archive and information on the comments displayed within the livestream. The interaction data 340 holds the display times of the interactions (gifts and/or comments), the gift IDs when the interactions are gifts, and the comments and commenter IDs when the interactions are comments. The interaction data 340 may be sorted in ascending or descending order of display time.

The interaction data generating unit 324 refers to the archive DB 328 to identify the stream ID corresponding to the archive ID included in the received archive viewing request. The interaction data generating unit 324 refers to the gift history DB 330 to identify the gift ID and display time corresponding to the identified stream ID. For each of the identified gift IDs, the interaction data generating unit 324 refers to the gift DB 320 to determine the type of the gift identified by the gift ID. When the gift type is the restricted, the interaction data generating unit 324 determines whether its expiration time has passed. In the example of FIG. 6, for the restricted gift “TE01”, the interaction data generating unit 324 determines that the expiration time (Dec. 31, 2022, 11:59 p.m.) has not passed when the current date (i.e., the time the archive viewing request was received) is Dec. 25, 2022, whereas it determines that the expiration time has passed when the current date is Jan. 1, 2023. When the type of the gift is normal, or when the type of the gift is restricted and the expiration time has not passed, the interaction data generating unit 324 registers the gift ID and display time of the subject gift in the interaction data 340.

The interaction data generating unit 324 does not register the subject gift ID in the interaction data 340 when its type is the restricted and its expiration time has passed. Thus, output of the effect of the subject gift is restricted during playback of the archive on the requesting user terminal. At the same time, the interaction data generating unit 324 changes the comment corresponding to the use of the subject gift so that the gift is not identified. The interaction data generating unit 324 identifies the comment corresponding to the identified stream ID by referring to the comment history DB 332. For each of the identified comments, the interaction data generating unit 324 determines whether the name of the subject gift is included. When included, the interaction data generating unit 324 replaces the name of the subject gift with a fixed character string (e.g., “expired gift”).

The interaction data generating unit 324 refers to the comment history DB 332 to identify the comment corresponding to the identified stream ID, the commenter ID, and the display time. The interaction data generating unit 324 determines for each of the identified comments whether the commenter ID is subject to restriction. When the commenter ID is not subject to restriction, the interaction data generating unit 324 determines whether the comment contains a restricted word. When the commenter ID of the subject comment is not subject to the restriction and does not contain the restricted word, the interaction data generating unit 324 registers the subject comment and its associated commenter ID and display time in the interaction data 340. When the commenter ID of the comment is subject to the restriction or when the comment contains the restricted word, the interaction data generating unit 324 does not register the subject comment in the interaction data 340. Thus, output of the subject comment is restricted during playback of the archive at the requesting user terminal.

The interaction data generating unit 324 refers to the gift history DB 330 and comment history DB 332 to identify the gift and comment corresponding to the archive ID included in the received archive viewing request. The interaction data generating unit 324 performs the same determination process and registration/non-registration process as described above for the identified gift and identified comment. Note that it is possible to hide the gift used during archive viewing and the comment entered on the screen by settings. In this case, the above identification process for the gifts and comments corresponding to the above archive IDs is not performed. In this way, when archive viewing requests are received, the output of the gift used or the comment entered or both in association with another archive viewing request for the same archive is restricted.

The archive providing unit 326 obtains, from the archive DB 328, the video data of the archive identified by the archive ID included in the received archive viewing request. The archive providing unit 326 generates the provision data by combining the obtained video data with the interaction data 340 generated by the interaction data generating unit 324. The archive providing unit 326 transmits the provision data to the requesting user terminal over the network NW. When playing the video data included in the received provision data, the out-of-livestream UI control unit 402 of the requesting user terminal causes a specified gift effect or comment to be displayed on the display at the display time specified in the interaction data 340 included in the same provision data. The out-of-livestream UI control unit 402 obtains the data of the effect of the gift corresponding to the gift ID from the effect DB 500.

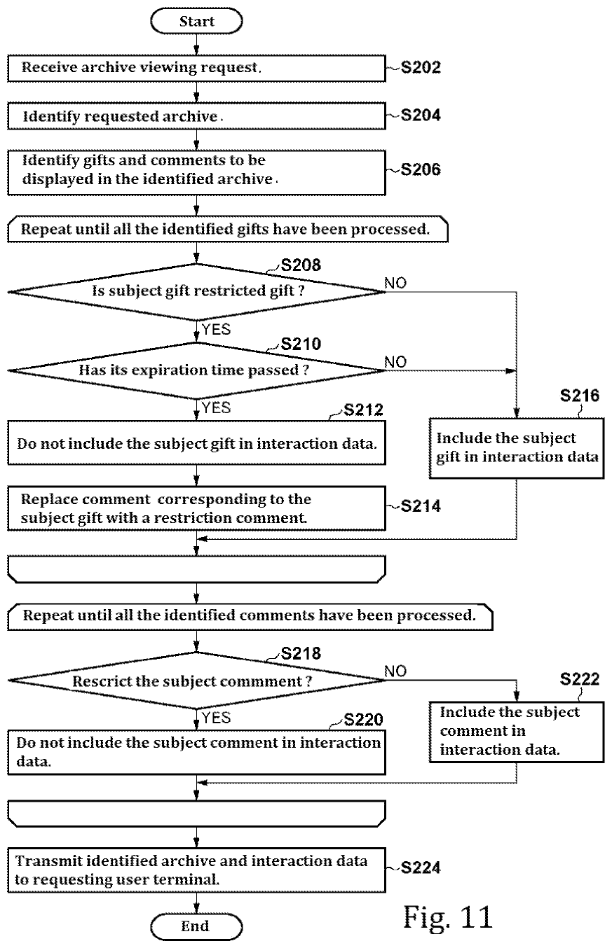

The operation of the live-streaming system 1 with the above configuration will be now described. FIG. 11 is a flowchart showing a series of steps performed in the live-streaming system when starting to view an archive. The server 10 receives an archive viewing request from a user terminal of an active user over the network NW (S202). The server 10 extracts the archive ID included in the received archive viewing request to identify the requested archive (S204). The server 10 then identifies a gift(s) and comment(s) to be displayed in the identified archive (S206).

The server 10 repeats the following process until all the gifts identified in step S206 have been processed. The server 10 determines whether a subject gift is the restricted gift (S208). When the subject gift is the restricted gift (Y in S208), the server 10 determines whether the expiration time of the subject gift has passed (S210). When the expiration time has passed (Y in S210), the server 10 does not include the subject gift in the interaction data (S212). The server 10 replaces a comment(s) corresponding to the subject gift with a restriction comment (S214). The restriction comment is a comment that does not contain any phrase that can identify the gift. When it is determined in step S208 that the gift is not the restricted gift (N in S208) or when it is determined in step S210 that the expiration has not passed (N in S210), the server 10 includes the subject gift in the interaction data (S216).

The server 10 repeats the following process until all the comments identified in step S206 have been processed. The server 10 determines whether to restrict a subject comment to be processed (S218). The server 10 determines to restrict the subject comment when the commenter of the subject comment is subject to restriction, or when the subject comment contains the restricted word. Otherwise, the server 10 determines not to restrict the subject comment. When the server 10 determined to restrict the subject comment (Y in S218), the server 10 does not include the subject comment in the interaction data (S220). When the server 10 determined not to restrict the subject comment (N in S218), the server 10 includes the subject comment in the interaction data (S222).

After all the identified gifts and comments are processed, the server 10 generates the provision data including the video data of the archive identified in step S204 and the interaction data, and transmits it to the requesting user terminal over the network NW (S224).

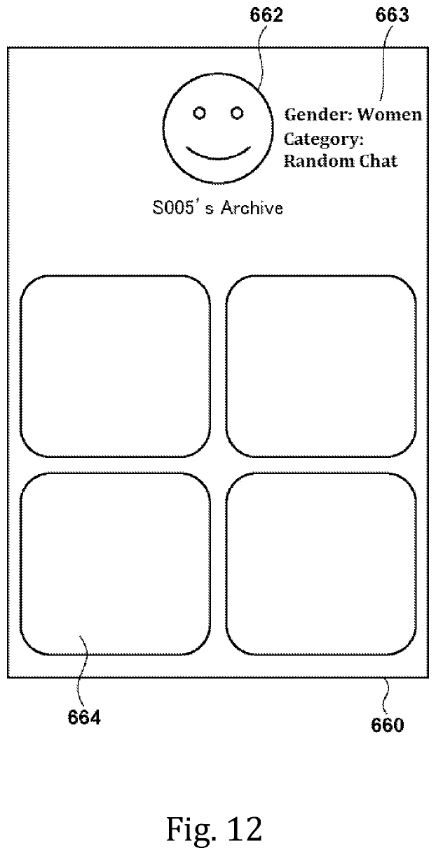

FIG. 12 is a representative screen image of a profile screen 660 displayed on the display of the active user's user terminal. The active user operates the user terminal to specify an interested live-streamer. The out-of-live-stream communication unit 404 in the user terminal communicates with the server 10 to receive profile information of the specified live-streamer and archive information. The archive information includes the archive ID corresponding to the live-stream ID of the specified live-streamer. The server 10 obtains this archive ID by referring to the archive DB 328. Based on the received information, the out-of-livestream UI control unit 402 of the user terminal generates the profile screen 660 and shows the generated screen on the display. The profile screen 660 includes an icon 662 indicative of the live-streamer, profile information 663 such as an attribute of the live-streamer, and thumbnails 664 representing archives of livestreams delivered by the live-streamer.

The user terminal allows selection of an archive by the active user on the profile screen 660. The active user taps the thumbnail 664 of a desired archive. The out-of-live-stream communication unit 404 generates an archive viewing request that includes the archive ID of the archive of the tapped thumbnail 664, and transmits the request to the server 10 over the network NW. The out-of-live-stream communication unit 404 receives the provision data corresponding to the transmitted archive viewing request from the server 10 over the network NW. The out-of-livestream UI control unit 402 generates an archive display screen 666 based on the received provision data and displays it on the display.

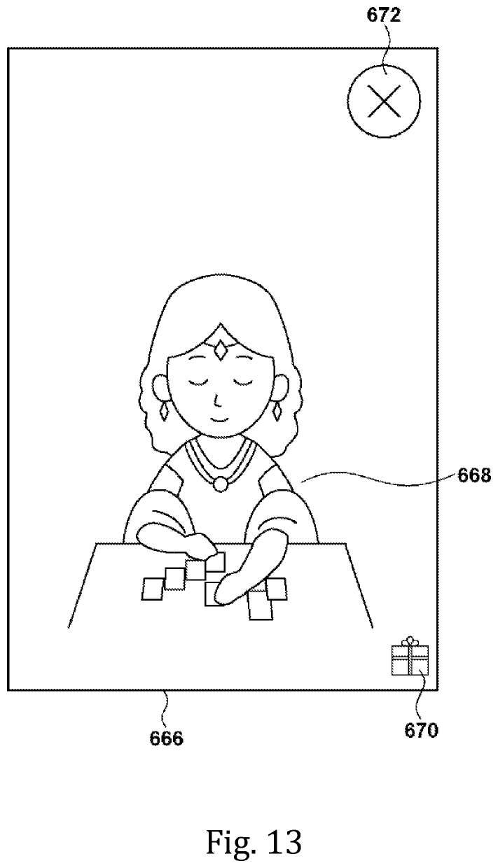

FIG. 13 is a representative screen image of the archive display screen 666 in non-display mode on the display of the active user's user terminal. The archive display screen 666 includes the live-streamer's past video image 668 obtained by playing back the video data included in the received provision data, an out-of-livestream gift object 670, and a viewing end button 672. In the non-display mode, neither gift effects nor comments are displayed.

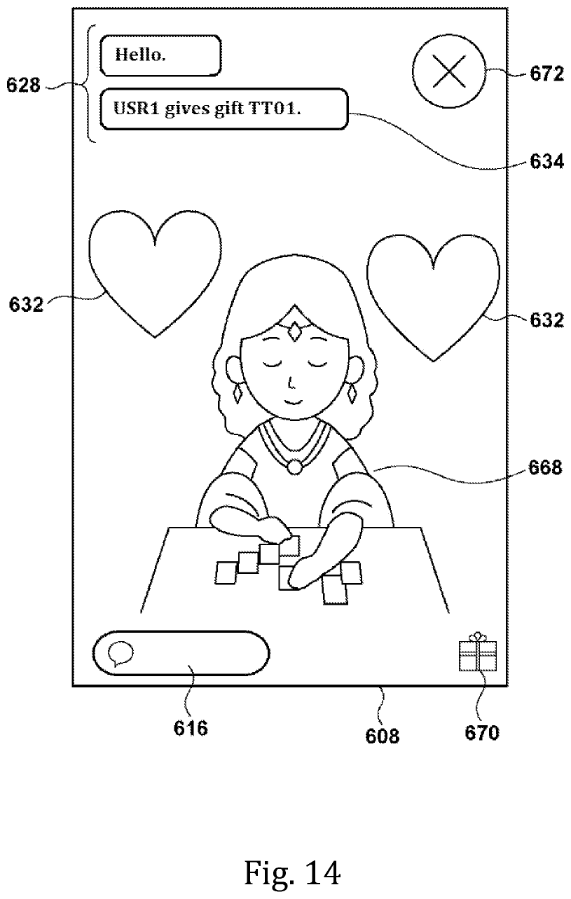

FIG. 14 is a representative screen image of the archive display screen 608 in the non-display mode on the display of the active user's user terminal. The archive display screen 666 in the non-display mode shown in FIG. 13 and the archive display screen 608 in the display mode shown in FIG. 14 can be switched by swiping the screen horizontally. The archive display screen 608 in the display mode includes the live-streamer's past video image 668, the out-of-livestream gift object 670, the end viewing button 672, a comment input region 616, a comment display region 628, and an effect 632. The archive display screen 608 includes a video image 668 obtained by playing the video data included in the provision data by the out-of-livestream UI control unit 402, and other objects such as the out-of-livestream gift object 670, the comment input region 616, the comment display region 628, an end viewing button 630, and the effect 632. These other objects are superimposed on the video image 668.

The out-of-livestream gift object 670 is an object for receiving, during playback of an archived livestream, an instruction from an active user to use an out-of-livestream gift for the live-streamer of the livestream. When an undelivered gift is used through the undelivered gift object 670, a corresponding entry is generated in the gift history DB 330. That entry holds the archive ID of the archive in which the undelivered gift was used, the gift ID of the undelivered gift used, and the display time.

The comment input region 616 is an area for entering comments during playback of an archive. When a comment is entered through the comment input region 616, a corresponding entry is generated in the comment history DB 332. That entry holds the archive ID of the archive in which the comment was entered, the user ID of the user who entered the comment (commenter ID), the comment, and the display time, in association with each other.

The out-of-livestream UI control unit 402 reads the interaction data included in the provision data and outputs each interaction when its display time arrives. In the example of the interaction data 340 of FIG. 10, the out-of-livestream UI control unit 402 displays the comment “Hello” in the comment display area 628 one minute and twenty-five seconds after the start of playback of the archive. Five minutes and thirty-two seconds later, the out-of-livestream UI control unit 402 displays the comment “USR1 gives gift TT01.” (comment 634 in FIG. 14) is displayed in the comment display region 628, and the data of the effect of the gift “TT01” (effect 632 in FIG. 14) is read out from the effect DB 500 and displayed on the archive display screen 608.

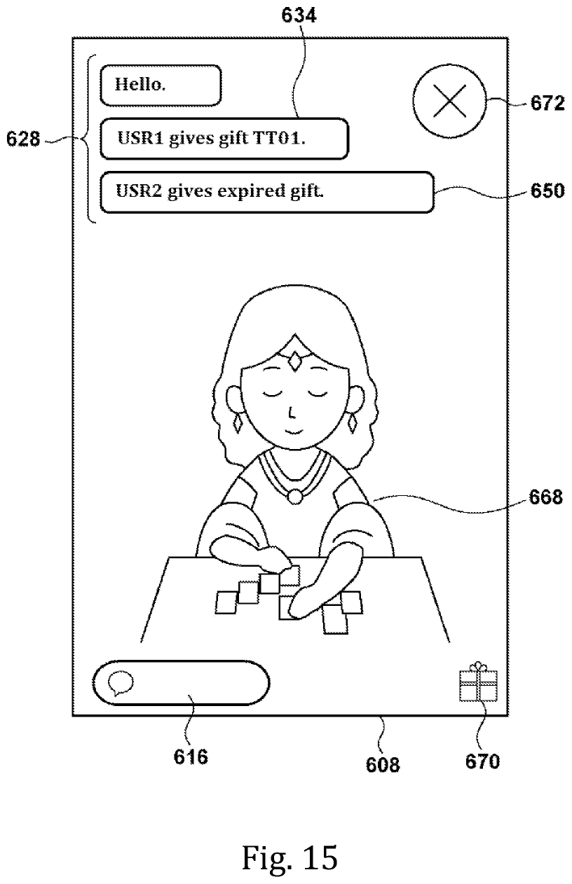

FIG. 15 is a representative screen image of the archive display screen 608 in the non-display mode on the display of the active user's user terminal. In the example of the interaction data 340 of FIG. 10, the out-of-livestream UI control unit 402 displays fifteen minutes and forty-two seconds after the playback start the restricted comment “USR2 gives an expired gift.” (comment 650 in FIG. 15) in the comment display region 628. The gift effect is not displayed. At the time when the livestream (“ST22” in FIG. 9), which is later archived, was being broadcast, USR2 gave the gift “TE01” fifteen minutes and forty-two seconds after the start of the livestream, and the corresponding effect was displayed on the live-streamer's user terminal and the viewer's user terminal. However, at the present time when the archive is being viewed, the expiration time of the gift “TE01” has passed, so the information of the gift “TE01” is not registered in the interaction data 340 on the server 10, and the corresponding comment is replaced with the restricted comment 650 that does not identify or associate with the gift “TE01”. As a result, the effect of gift “TE01” is not displayed in the archive display screen 608 in the display mode, but the restricted comment 650 is displayed.

In the above embodiment, an example of a holding unit includes a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

According to the live-streaming system 1, when providing an archive of a livestream, interactions that satisfy the restriction criterion are detected and the output of such interactions can be restricted. This enables more finely cope with the situations. For example, when a gift effect has an expiration time based on a copyright agreement, by setting the expiration time as a restriction criterion, the gift effect can be made unavailable during archive playback after the expiration time has passed. Alternatively, for an event-only gift in a livestream, by setting the end of the event period as the expiration time for the event-only gift, the event-only gift can be made unavailable during viewing of the archive playback after the event is over.

In the live-streaming system 1, when the output of a gift is restricted during archive viewing, the comments corresponding to that gift are also changed so that the gift cannot be identified. This increases confidentiality of the restricted gift.

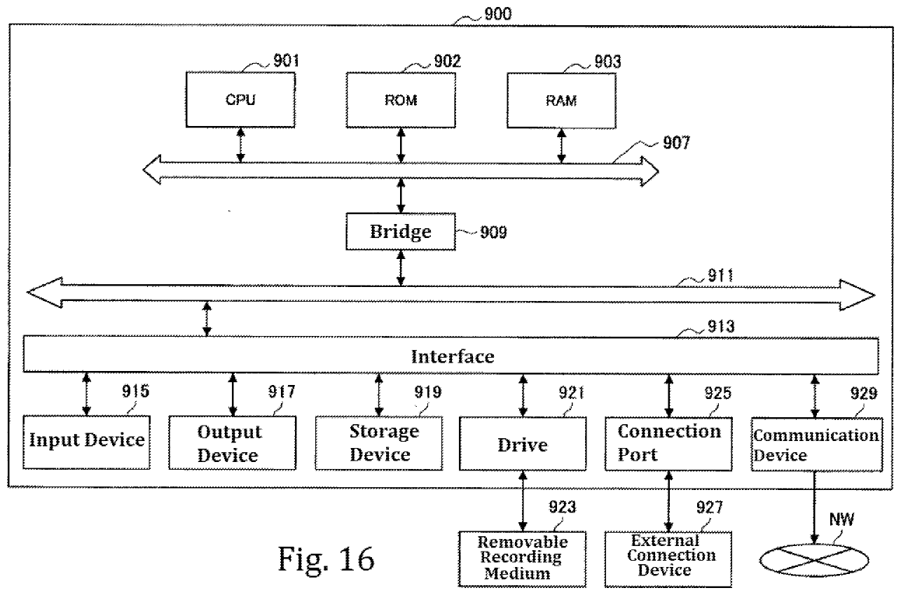

Referring to FIG. 16, the hardware configuration of an information processing device relating to an embodiment of the disclosure will be now described. FIG. 16 is a block diagram showing an example of the hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a processing circuit such as a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs @including sets of instructions@, calculation parameters, and the like used by the CPU 901. The RAM 903 serves as a primary storage that stores @programs including sets of instructions@ to be used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the live-streaming system 1 in the embodiment have been described. This embodiment is merely an example, and it will be understood by those skilled in the art that various modifications are possible by combining the respective components and processes, and that such modifications are also within the scope of the present disclosure.

In the above embodiment, the case is described where the server 10 has a list of gifts to be restricted (gift DB 320) and the server 10 determines whether to restrict the output of interactions pertaining to the archive viewing requests, but the embodiment is not limited to this case. For example, the user terminal from which the archive viewing request is sent may have the list of restricted gifts, and the user terminal may determine whether to restrict the output of interactions pertaining to the archive viewing requests.

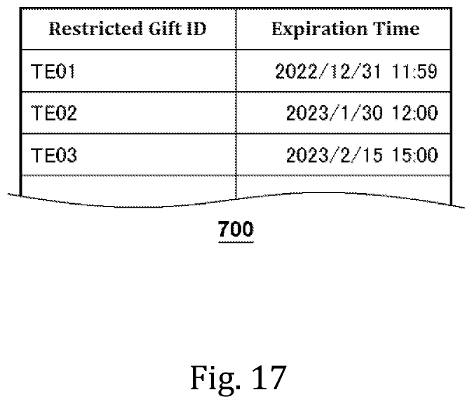

FIG. 17 is a data structure diagram showing an example of a restricted gift list 700 held by a user terminal from which an archive viewing request is sent. The restricted gift list 700 may be provided from the server 10 to the user terminal over the network NW when the live-streaming application is activated at the user terminal. Alternatively, the restricted gift list 700 may be provided from the server 10 to the user terminal over the network NW when the archive viewing request is generated. The restricted gift list 700 holds the gift IDs of the restricted gifts and the expiration times of the gifts in association with each other. The server 10 may periodically update the restricted gift list 700 over the network NW.

In this modification example, the user terminal transmits the archive viewing request to the server 10 over the network NW. When the server 10 accepts the archive viewing request, the server 10 refers to the archive DB 328 to identify the stream ID corresponding to the archive ID included in the received archive viewing request. The server 10 refers to the gift history DB 330 to identify the gift ID and display time corresponding to the identified stream ID. The server 10 registers the identified gift ID and display time in the interaction data. The server 10 obtains, from the archive DB 328, the video data of the archive identified by the archive ID included in the received archive viewing request. The server 10 generates the provision data including the obtained video data and interaction data. The server 10 transmits the provision data to the requesting user terminal over the network NW.

When playing back the video data of the archived livestream included in the provision data, the requesting user terminal determines whether to output the effect corresponding to a gift that was used in the livestream by a participant at the time when the livestream was broadcast. More specifically, when the display time has come, the requesting user terminal performs the following determination process for each of the gifts included in the interaction data contained in the provision data. The user terminal refers to the restricted gift list 700 and determines whether the gift ID of the gift whose display time has come exists in the restricted gift list 700. When it exists, the user terminal determines whether the corresponding expiration time has passed. When the expiration time has passed, the user terminal determines that it does not display the effect of the gift whose display time has come. In this case, the user terminal replaces the comment corresponding to the use of the gift whose expiration time has passed with a restricted comment. Whereas when the gift ID does not exist in the restricted gift list 700, or when it exists but the expiration time has not yet passed, the user terminal determines that it displays the effect of the gift whose display time has come.

In another modification example, the server 10 may have the restricted gift list (gift DB 320) and determine whether the user terminal from which the archive viewing request is sent should restrict the output of interactions pertaining to the archive viewing request.

In the above embodiment, described is the case where the type of the subject gift is determined, and when it is the restricted type, its expiration time is checked. However the embodiment is not limited to this. For example, there may be no need to set types for the gifts. In this case, the interaction data generating unit 324 refers to the gift DB 320 and determines whether the expiration time has passed when the expiration time has been set for the subject gift. Alternatively, in case of gifts for which no expiration time should be set, the expiration time can be the system's upper limit value. In this case, it is not necessary to check whether the expiration time has been set or not.

Alternatively, the expiration time may not be set for the gifts. In this case, when the gift is of the restricted type, its output is restricted. In this case, for example, a gift that can only be viewed during a real-time livestream (a gift that cannot be viewed during archive viewing) may be provided.

In the above embodiment, described is the case where, upon reception of the archive viewing request, all interactions that took place in the livestream for which its archive is requested are extracted, it is determined whether the restriction criterion is met for each interaction, and the interaction data is generated based on the determination. However the embodiment is not limited to this. For example, it is also possible to periodically (e.g., once every ten seconds, once every minute, etc.) extract interactions in the next period while the archive is being provided, and determine whether each extracted interaction satisfies the restriction criterion. Alternatively, it may determine whether the interaction satisfies the restriction criterion each time the display time for the interaction comes during the provision of the archive.

In the above embodiment, described is the case where, when the output of a gift is restricted, the content of the comment corresponding to that gift is adjusted. However the embodiment is not limited to this. The corresponding comment may not be adjusted, or the corresponding comment may be deleted.

The return rate of the gift, which indicates the ratio of the reward to be awarded to the price points in the embodiment is merely an example, and the return rate may be appropriately set by the administrator of the live-streaming system 1, for example.

The technical idea according to the embodiment may be applied to live commerce or virtual live-streaming using an avatar that moves in synchronization with the movement of the streamer instead of the image of the streamer.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10. For example, the superimposition of a predetermined frame image on an image of the video data performed by the viewer's user terminal may be performed by the server 10 or may be performed by the streamer's user terminal.

What is claimed is:

1. A server, comprising:
a storage adapted to hold video data of past livestreams; and
a generating unit adapted to generate, in response to reception of a viewing request for a past livestream, provision data for the viewing request, the provision data being generated such that, among interactions made in the livestream, output of an interaction that meets a predetermined criterion is restricted.

2. The server of claim 1, wherein the interactions include gifts used by participants in the livestream, and
wherein, when a gift is a predetermined type, the generating unit generates the provision data such that output of the gift is restricted.

3. The server of claim 1, wherein the interactions include gifts used by participants in the livestream, and
wherein each of the gifts has an expiration time, and the generating unit generates the provision data such that output of a gift is restricted if the expiration time of the gift has already passed at a time of the reception of the viewing request.

4. The server of claim 2, wherein the interactions include comments displayed in the livestream, and
wherein, when output of a gift is restricted, the generating unit changes a comment corresponding to use of the gift so that the gift is not identified.

5. The server of claim 4, wherein, in response to the reception of the viewing request for the past livestream, the generating unit generates the provision data such that output of a gift used or comment entered or both in association with another viewing request for the same past livestream is restricted.

6. The server of claim 3, further comprising:
a gift history holding unit adapted to hold information on gifts used in the past livestreams; and
a gift holding unit adapted to hold expiration times of the gifts,
wherein the generating unit refers to the gift history holding unit to identify a gift used in the past livestream for which the viewing request is made, and
wherein the generating unit refers to the gift holding unit to determine whether the expiration time of the identified gift has passed.

7. A terminal, comprising:
one or more processors; and
memory storing one or more computer programs configured to be executed by the one or more processors,
the one or more computer programs including instructions for:
transmitting a viewing request for a past livestream to a server over a network; and
determining, when playing back video data of the past livestream corresponding to the viewing request, whether to output an effect corresponding to a gift used in the livestream by a participant at a time when the livestream was broadcast.

8. The terminal of claim 7, wherein the determining includes referring to a holding unit that holds an expiration time of the gift.

9. The terminal of claim 8, wherein the determining includes determining that the effect corresponding to the gift is not outputted when the expiration time of the gift has passed, and
wherein the one or more computer programs further includes instructions for:
changing a comment corresponding to use of the gift whose expiration time has passed so that the gift is not identified.

10. A method comprising:
holding video data of past livestreams; and
generating, in response to reception of a viewing request for a past livestream, provision data for the viewing request, the provision data being generated such that, among interactions made in the livestream, output of an interaction that meets a predetermined criterion is restricted.

11. The method of claim 10, wherein the interactions include gifts used by participants in the livestream, and
wherein, when a gift is a predetermined type, the generating includes generating the provision data such that output of the gift is restricted.

12. The method of claim 10, wherein the interactions include gifts used by participants in the livestream, and
wherein each of the gifts has an expiration time, and the generating includes generating the provision data such that output of a gift is restricted if the expiration time of the gift has already passed at a time of the reception of the viewing request.

13. The method of claim 11, wherein the interactions include comments displayed in the livestream, and
wherein, when output of a gift is restricted, the generating includes changing a comment corresponding to use of the gift so that the gift is not identified.

14. The method of claim 13, wherein, the generating includes, in response to the reception of the viewing request for the past livestream, generating the provision data such that output of a gift used or comment entered or both in association with another viewing request for the same past livestream is restricted.

15. The method of claim 12, further comprising:
holding a gift history, which is information on gifts used in the past livestreams; and
holding information on expiration times of the gifts,
wherein the generating includes referring to the gift history to identify a gift used in the past livestream for which the viewing request is made, and
wherein the generating includes referring to the information on expiration times of the gifts to determine whether the expiration time of the identified gift has passed.
